(19) United States
(12) Patent Application Publication
(10) Pub. No.: US 2010/0263346 A1
(43) Pub. Date: Oct. 21, 2010

(54) DEBRIS COLLECTOR FOR A GARDENING TOOL

(76) Inventor: Wesley Westgarde, Houston (CA)

Correspondence Address: KLARQUIST SPARKMAN, LLP, 121 SW SALMON STREET, SUITE 1600, PORTLAND, OR, 97204, US

(21) Appl. No.: 12/764,885

(22) Filed: Apr. 21, 2010

Related U.S. Application Data
(60) Provisional application No. 61/171,316, filed on Apr. 21, 2009.

(51) Int. Cl. A47L 13/52; A01D 7/00

(52) U.S. Cl. 56/400.04; 294/55

(57) ABSTRACT

A debris collector for a gardening tool which includes a shaft, a working implement oriented in angular relation to the shaft, and a frame securing the working implement to the shaft. The frame defines an enclosure. The debris collector has a scoop that fits within the enclosure as defined by the frame. The scoop has a peripheral edge. A hanger profile is positioned along the peripheral edge such that the hanger profile engaging the frame when the scoop is positioned in the enclosure.

### FIELD OF THE INVENTION

The invention relates to a debris collector for a gardening tool suitable for use in landscaping and general lawn and garden upkeep.

### BACKGROUND OF THE INVENTION

Conventional rakes, particularly tined rakes are used for gathering or accumulating leaves, grass and the like in landscaping and general lawn and garden upkeep. Conventional rakes however, cannot gather or temporarily store particulate matter and liquids such as sand and water also commonly found in such applications.

### SUMMARY OF THE INVENTION

In accordance with the present invention, there is provided a debris collector for a gardening tool which includes a shaft, a working implement oriented in angular relation to the shaft, and a frame securing the working implement to the shaft. The frame defines an enclosure. The debris collector has a scoop that fits within the enclosure as defined by the frame. The scoop has a peripheral edge. A hanger profile is positioned along the peripheral edge such that the hanger profile engaging the frame when the scoop is positioned in the enclosure.

### SUMMARY OF THE DRAWINGS

FIG. 1 is a perspective view of a gardening tool of the present invention shown without a debris collector.

FIG. 2 is an top plan view of the debris collector for a gardening tool of shown in FIG. 1 with a debris collector attached.

FIG. 3 is a top plan view of debris collector for a gardening tool shown in FIG. 2.

FIG. 4 is a front elevation view of the debris collector for a gardening tool shown in FIG. 3.

FIG. 5 is a side elevation view of the debris collector for a gardening tool shown in FIG. 3.

FIG. 6 is a side elevation view of the debris collector wherein the debris collector is shown being attached to the gardening tool.

FIG. 7 is a side elevation view of the debris collector wherein the debris collector is shown having been attached to a gardening tool.

FIG. 8 is a side elevation view of the gardening tool with the debris collector attached in preparation for use.

FIGS. 9 through 13 are slide elevation views showing the debris collector being attached to a gardening tool.

FIG. 14 is a rear elevation view of a variation of the debris collector for a gardening tool having a debris collector fabricated from a mesh material.

FIG. 15 is a front elevation view of a further variation of the debris collector for a gardening tool wherein the debris collector is provided with a perforated portion.

FIG. 16 is a rear view of debris collector for a gardening tool of FIG. 15 with a closure covering the perforated portion of the debris collector.

FIG. 17 is a rear view of the debris collector for a gardening tool with the closure held in place by a sliding track.

FIG. 18 is a rear view of debris collector for a gardening tool illustrated in FIG. 17 with the closure being removed from sliding track.

FIG. 19 is a rear view of the debris collector for a gardening tool with the closure being secured to the debris collector by a hinge in the open position.

FIG. 20 is a rear view of the debris collector in FIG. 18 with the closure in the closed position.

FIG. 21 is a rear perspective view of the debris collector with a securing strip.

### DETAILED DESCRIPTION WITH REFERENCE TO THE DRAWINGS

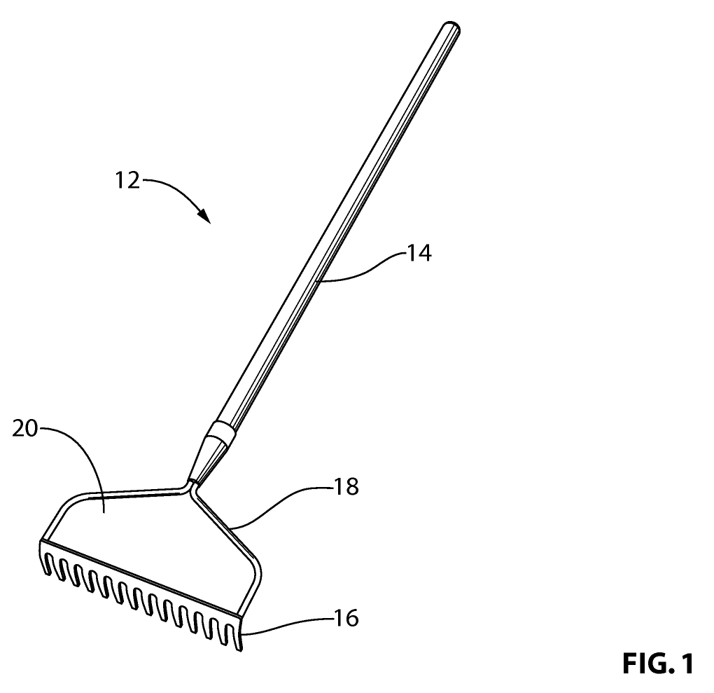

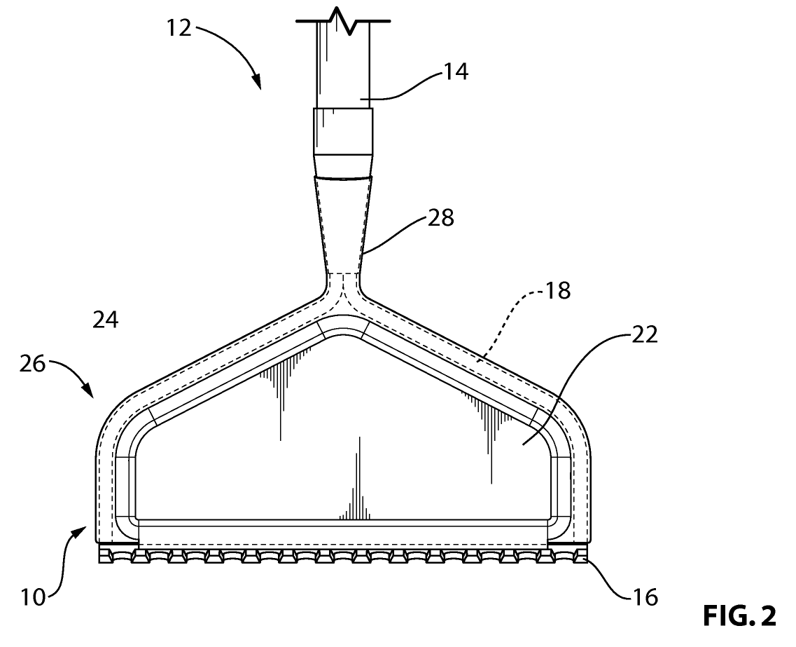

Referring to FIGS. 1 and 2, there is illustrated a debris collector for a gardening tool of the invention generally referenced herein as numeral 10. Referring to FIG. 1, there is illustrated a gardening tool generally referenced by numeral 12 which has a shaft 14, a working implement 16 oriented in angular relation to shaft 14, and a frame 18 securing working implement 16 to shaft 14. Frame 18 defines an enclosure generally reference by numeral 20. Referring to FIG. 2, garden tool 12 is illustrated with a debris collector 10. Debris collector 10 has a scoop 22 that fits within enclosure 20 which is defined by frame 18. Scoop 22 has a peripheral edge 24 and a hanger profile 26 that is positioned along peripheral edge 24. Hanger profile 26 engages frame 18 when scoop 22 is positioned in enclosure 20. In the illustrated embodiment, debris collector 10 is provided with an elongated member 28 extending past peripheral edge 24 of scoop 22, and a clamp 30 on elongated member 28 for clamping onto shaft 14 of garden tool 12.

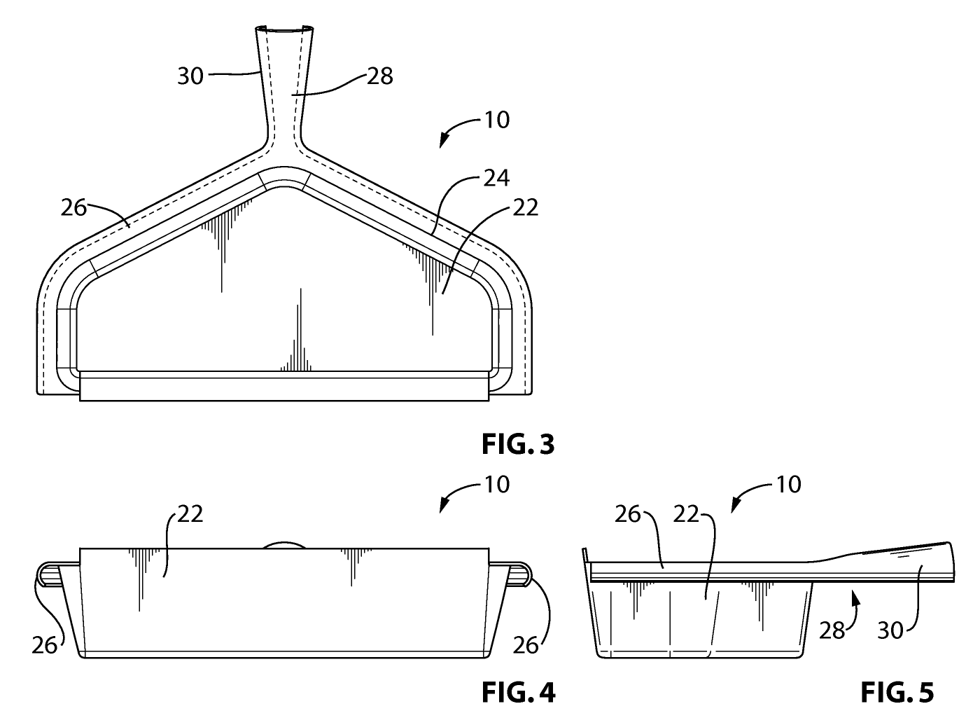

Referring to FIG. 3, debris collector 10 is formed from a resilient, extruded plastic material. However, it should be appreciated that any number of materials, including metal or composite materials may be used to where plastic would not be application appropriate, for example, the use of gardening tool 12 for fire management.

It should be further appreciated that although the embodiment is illustrated as having been secured by snap fit, clamps, release buckles or sliding keepers may also be used.

### Operation

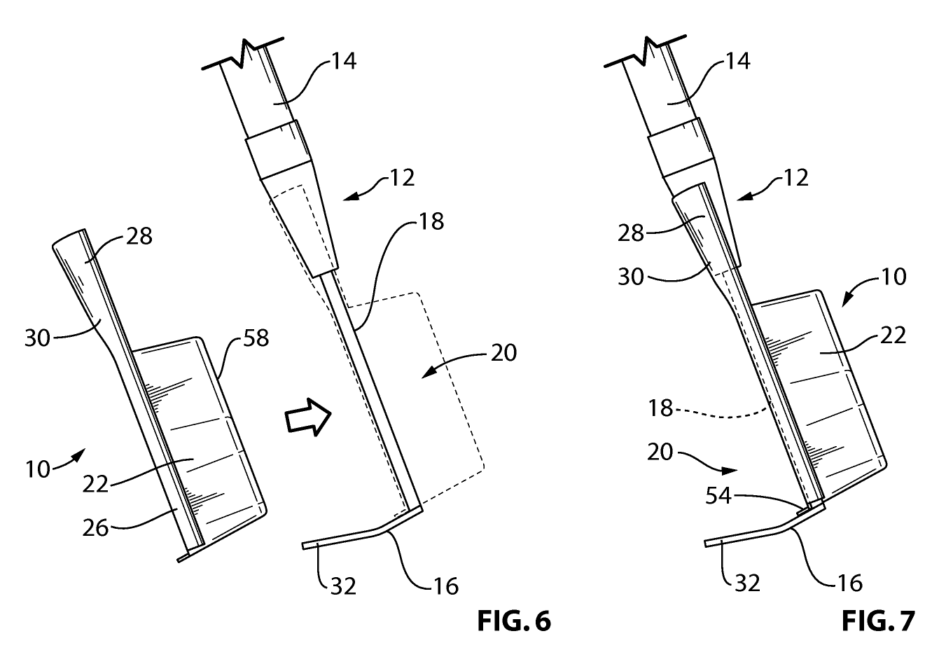

Referring to FIG. 6, gardening tool 12 may be used as a conventional rake with or without debris collector 10. For example, where working implement 16 on gardening tool 12 is a conventional rake, tines 32 are directed towards the ground and a user grasps and pulls with shaft 14 to gather or accumulate leaves, grass and other similar debris 34 found in landscaping, and lawn and garden applications. It will be appreciated that while the illustrated embodiments show working implement as a rake, it may also be a hoe, a claw cultivator, a tiller, a weeding tool, weeder or other like implement.

Continuing to refer to FIG. 6, debris collector 10 when detached from gardening tool 12, may be used as a conventional scoop. A user grasps elongated member 28 to gather or accumulate leaves, grass and other similar debris 34 found in landscaping, and lawn and garden applications. Debris collector 10 may also be used to gather, transport or temporarily store particulate matter and liquids that would otherwise pass between tines 32.

Now referring to FIGS. 6 and 7, debris collector 10 may be attached by orienting scoop 22 to correspond with enclosure 20 defined by frame 18 of garden tool 12, and inserting scoop 22 through enclosure 20. During the insertion process, hanger profile snaps releasably onto frame 18, and likewise clamp 30 of elongated member 28 similarly releasably snaps onto shaft 14. In combination, these attachment means ensure that debris collector 10 becomes a secure component of gardening tool 10 during operation by supplying substantially continuous points of contact along frame 18. Although scoop 38 is securely attached at continuous points of contact, detachment is readily accomplished by releasing hanger profile from frame 18 as well as releasing clamp 30 of elongate member 28 from shaft 14. Attachment and detachment may be readily accomplished by a single person using his or her hands. It should be appreciated that debris collector 10 can also be permanently fixed to frame 18 and working implement 16 if so desired. Various means can be used to fix debris collector 10 to garden tool including but not limited to bolting, welding, and even integrally forming debris collector 10 with garden tool 12 during fabrication.

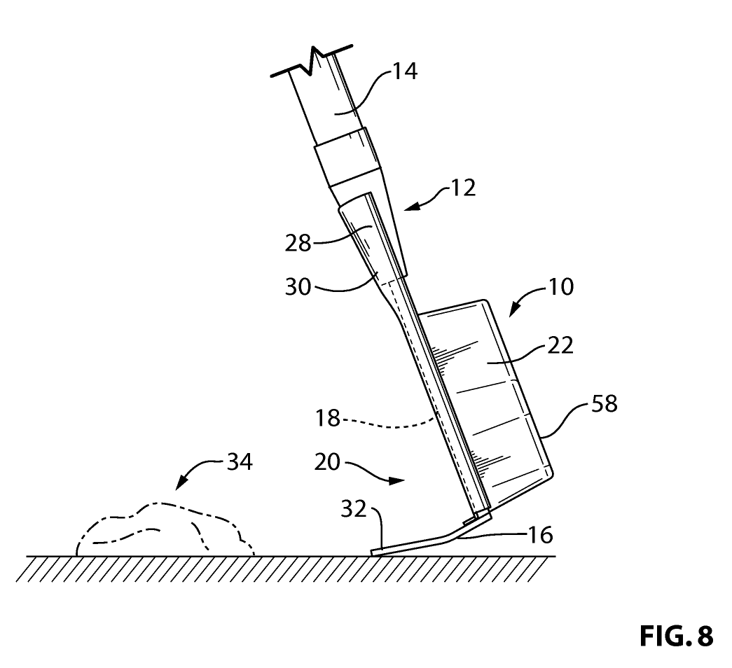

Now referring to FIG. 8, gardening tool 12, with debris collector 10 attached, may be used in an additional, unconventional manner. Rather than directing tines 24 towards the ground and pulling in a raking motion, a user grasps shaft 14 and positions tines 32 substantially horizontally and maneuvers gardening tool 12 in a scooping motion in order to direct leaves, grass and other similar debris 47 found in landscaping, and lawn and garden applications into debris collector 10. Because illustrated scoop 22 is non-porous, using gardening tool 12 in this unconventional manner will allow the gathering, transporting or temporarily storage of particulate matter and liquids, such as sand, gravel and water.

### Use and Operation:

Gardening tool 12 can also be used for the purpose of scooping and or picking up material and or liquids.

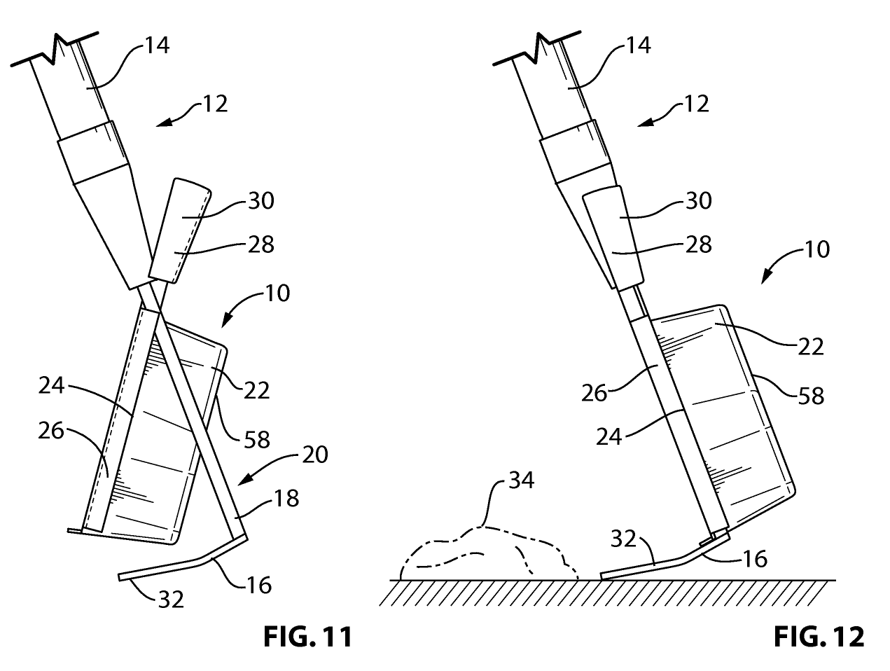

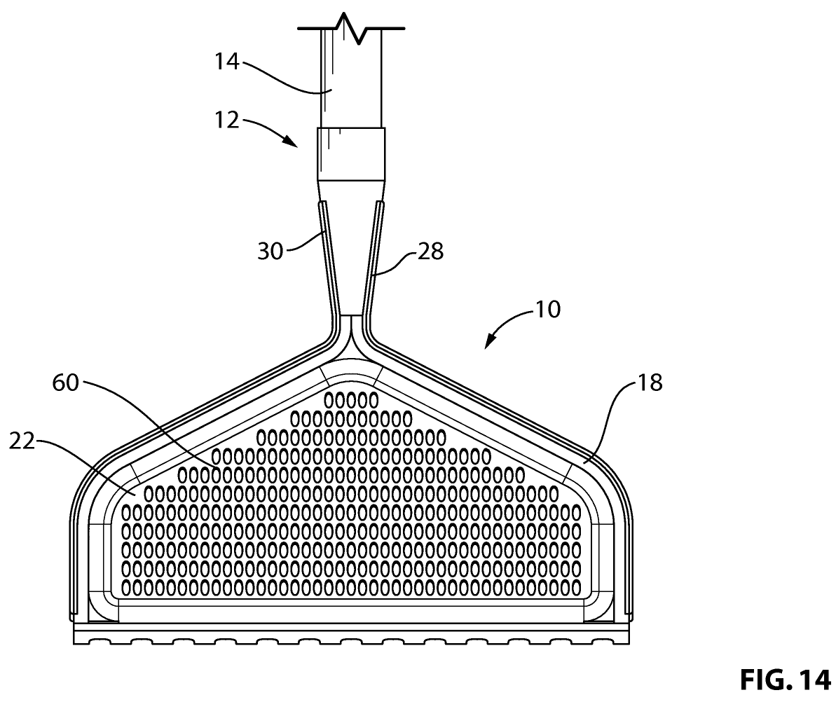

Referring to FIGS. 1 through 21, depending on preference and intended use of gardening tool 12, debris collector 10 may be detachable or incorporated, fixed or manufactured as being part of gardening tool 12. Scoop 22 of debris collector 10 may be substantially curved with a deeper cavity or it may be substantially planer with a shallow depth. Although scoop 22 is illustrated as having a flat bottom, scoop 22 could also have a rounded, or curved bottom. It may be manufactured from any type of materials or a combination of materials such as metal or plastic. A solid material is most desirable for debris collector 10 when collecting fine materials such as sands, or liquids so that such materials will not escape. An example would be when debris collector 10 is dipped for retrieving water for plants. There are other applications where it may be desirable to make scoop 22 or a portion of scoop 22 from mesh or a screen as illustrated in FIGS. 14 through 16 such as for picking up rocks or like dense materials yet still allowing water, sand, or other fine materials to pass through scoop 22 and mesh material.

Where debris collector 10 is removable, it may be fastened with various types of devices including but not limited to friction fit, release buckles, and sliding keepers. In addition, when debris collector 10 is removable, it can incorporate elongate member 28 which can operate as a handle to greatly improve the handling and operating debris collector 10. Elongate member 28 can be clamped with clamp 30 onto shaft 14 so as to be neat and compactly stored when gardening tool 12 is in normal usage. It should be noted that elongate member 28 can be clamped on shaft 14 on any side or angle.

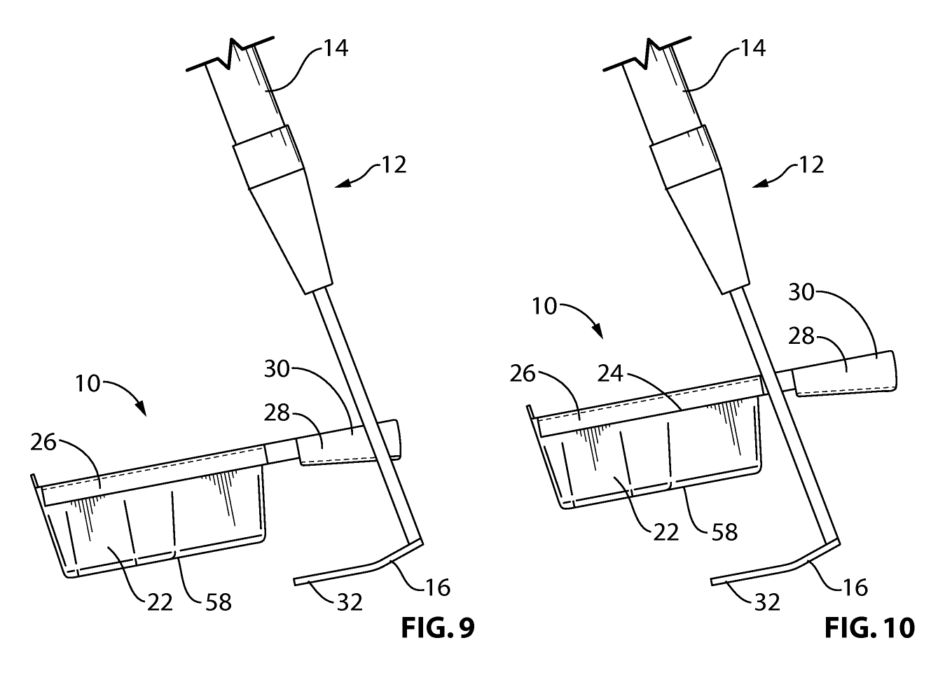

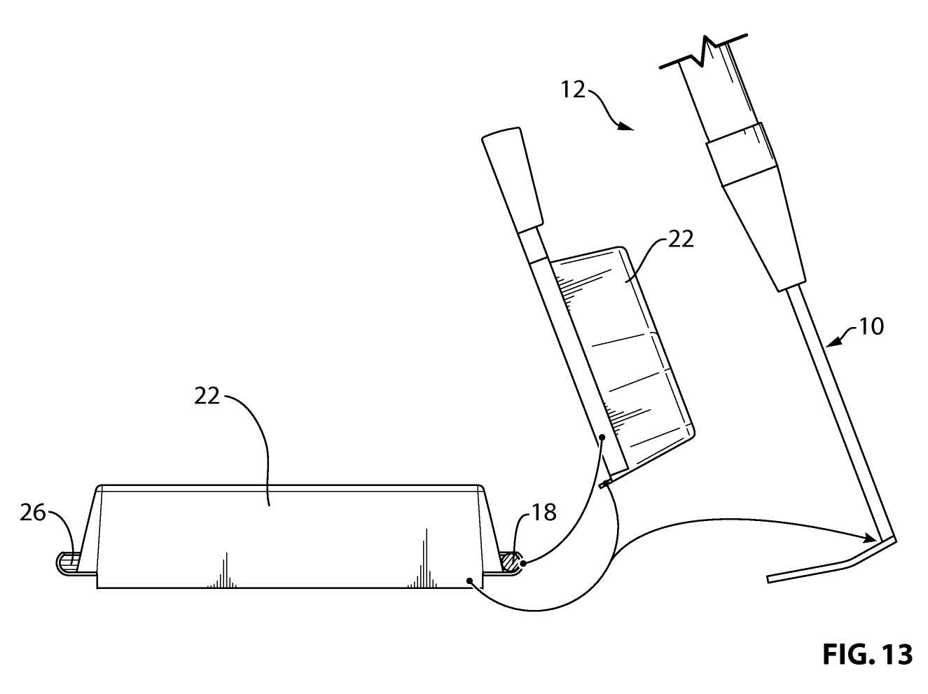

Referring to FIGS. 9 through 13, there is illustrated one manner of attaching debris collector to gardening tool 12. Referring to FIG. 9, to attach debris collector 10 to gardening tool 12, elongate member 28 of debris collector will pass through enclosure 20. Referring to FIG. 10, debris collector 10 will be moved upwards and start to roll towards shaft 14, it snaps or slips onto frame 18. Referring to FIG. 12, once debris collector has popped into position on frame 18, hanger edge 24 grip by friction, so as to prevent debris collector 10 from falling off frame 18 if scoop 22 is bumped from the rear. Referring to FIG. 13,

To remove debris collector 10, pressure is applied to a back area 58 of scoop 22 to free it from frame 18. Once scoop 22 clears working implement 16 then elongate member 28 can be lifted and debris collector 10 can be lowered out the same way it went in.

Where debris collector 10 is removable, it can be detached and used in conjunction with the working implement 16 as a pan or tray for accumulating liquids or particulate materials being raked. Debris collector 10 may also be used independently as a digging or scooping implement. This will greatly assist people such as gardeners, landscapers, and planters.

### Variations:

Referring to FIG. 14, there is illustrated a variation of debris collector fabricated of a mesh material 60 such that scoop 22 operates as sieve allowing liquids and/or particulate matter to pass through the perforated or mesh material 60. The size of the mesh openings or perforations determine the size of the particulate matter permitted to pass through.

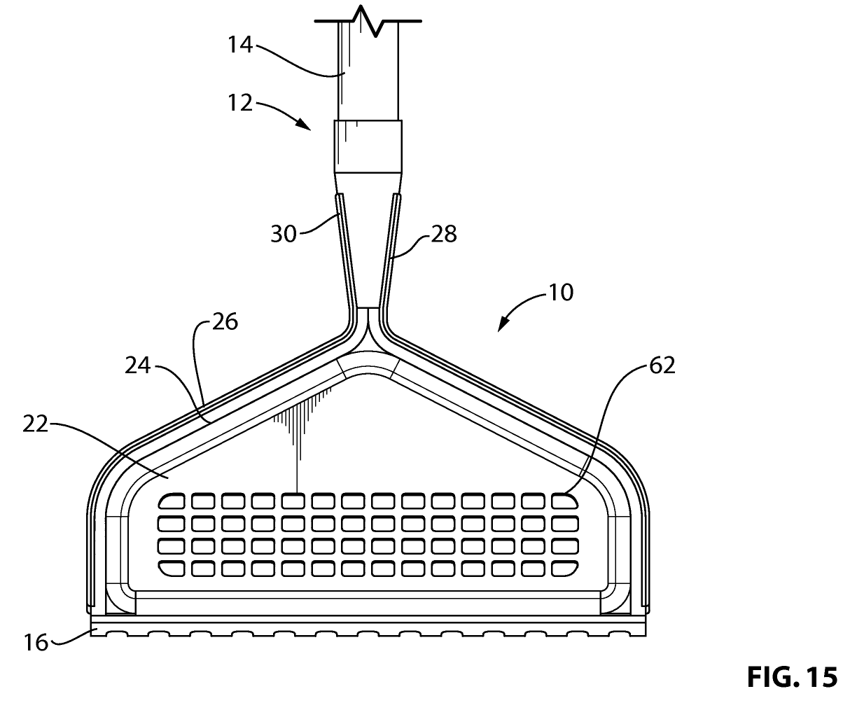

Referring to FIG. 15, there is illustrated a variation of debris collector 10 which is fabricated of a solid material but includes a portion 62 which is perforated or mesh. Again, the size of the mesh openings or perforations determine the size of the particulate matter permitted to pass through.

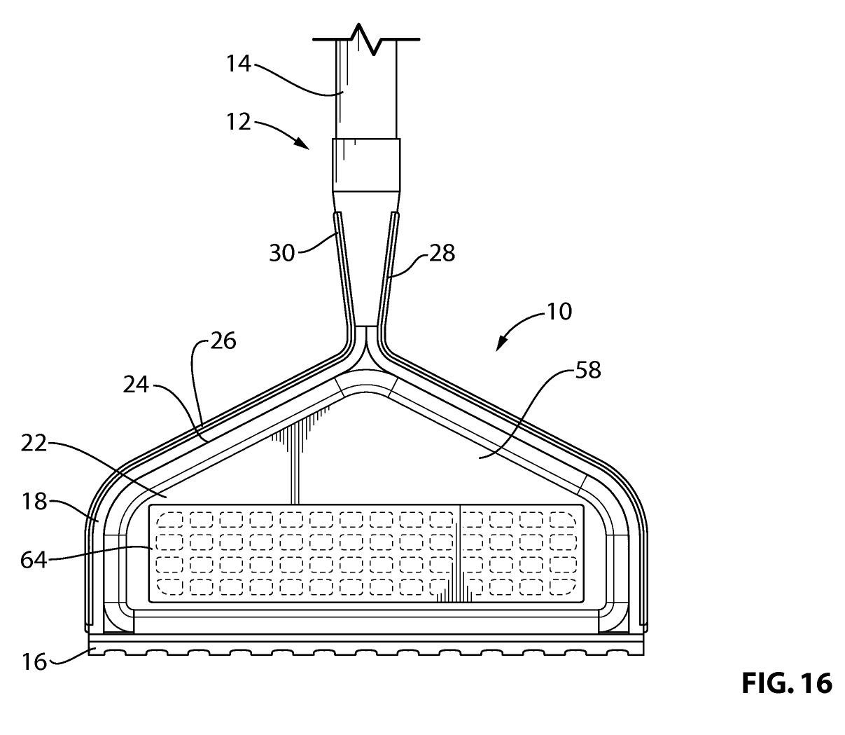

Referring to FIG. 16, a closure 64 can be provided for covering perforated portion 62 to prevent the passage of liquids or particulate matter through perforated portion 62.

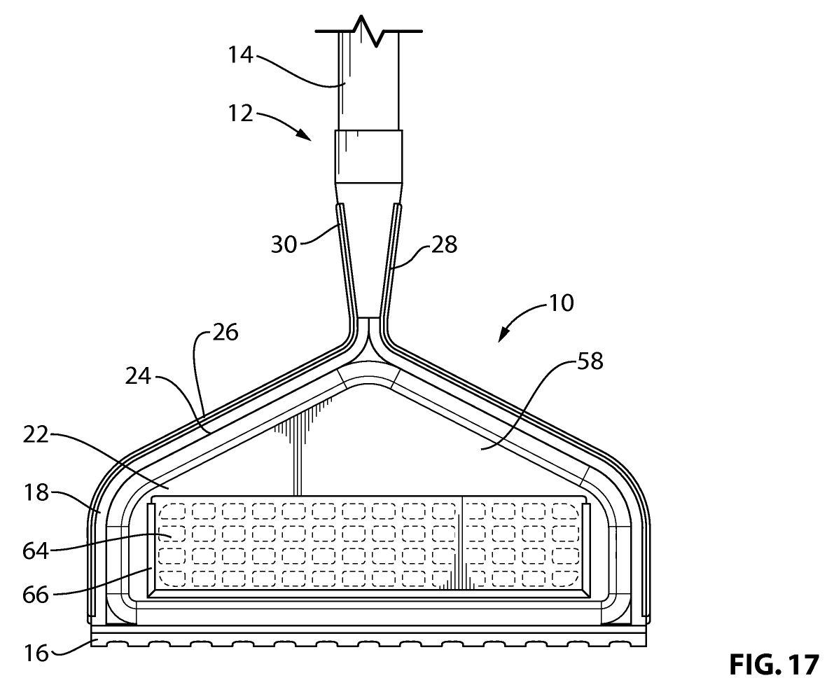

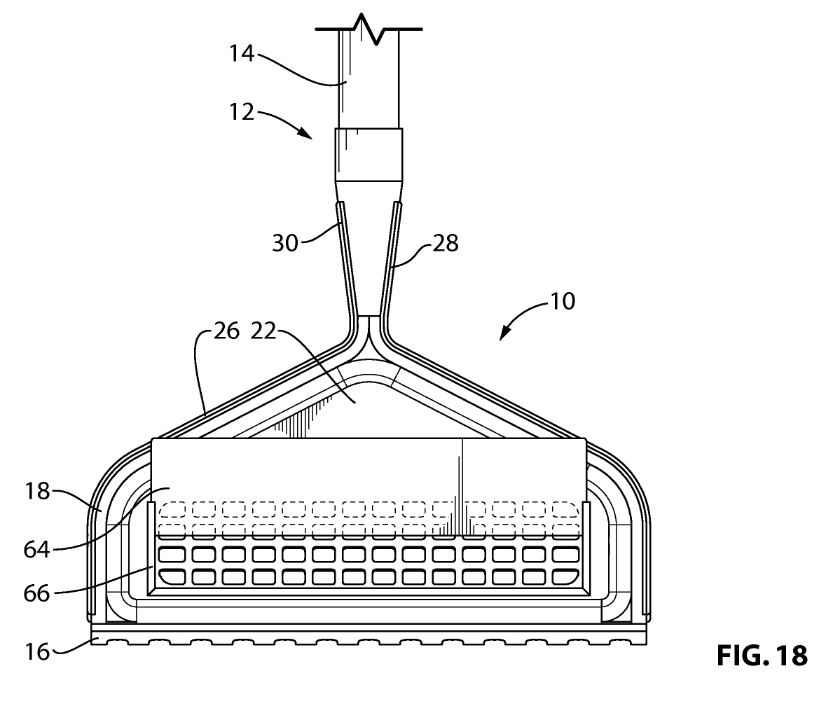

Referring to FIG. 17, closure 64 can be held in place by means of a sliding track 66 as illustrated. It will be appreciated that other means can be used to maintain closure in place till it is desired to remove it. Such means can include snap fit, clasps, or swing tabs. Closure 64 can be removed by sliding closure 64 up out of sliding track 66 as illustrated in FIG. 18.

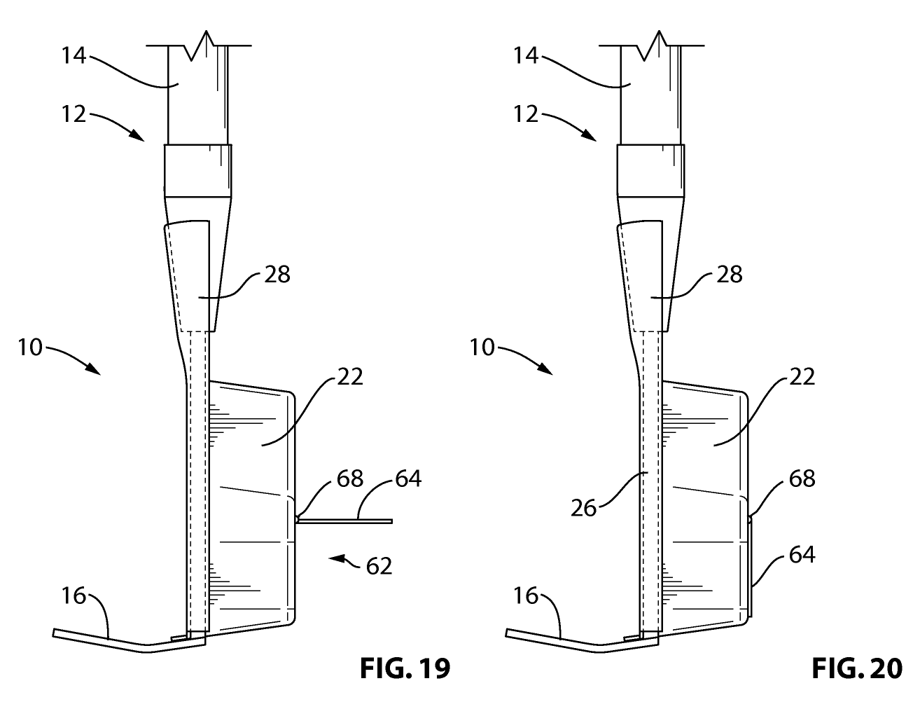

Referring to FIGS. 19 and 20, closure 64 can also be secured to debris collector 10 in a manner in which it is movable from a open position allowing liquid and particulate matter to pass through perforated portion as illustrated in FIG. 19 and a closed position whereby closure 64 covers perforated portion 62 of scoop 22 to prevent the passing of liquid or particulate matter through perforated portion 62 as illustrated in FIG. 20. In the variation illustrated in FIGS. 19 and 20, a hinge 68 is provided for movably securing closure 64 to scoop 22 however it will be appreciate that other means can also be used such as a living hinge. Closure 64 can be moved from open to closed positions manually or by means of attached handles or levers.

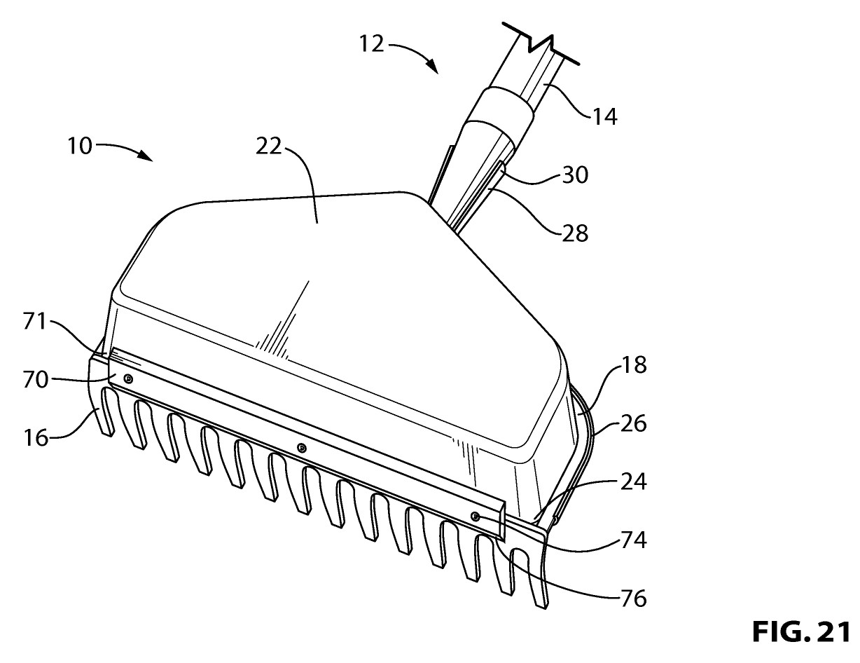

Referring to FIG. 21, debris collector 10 can also be fabricated with a securing lip 70 along a lower portion 71 of peripheral edge 24 of scoop 22. Where debris collector 10 is removable, securing lip 70 grips working implement 16. Where debris collector 10 is fixed, rivets 74 as illustrated or other securing means such as welding can be used to permanently attach securing lip 70 to working implement 16. Securing lip 70 works with hanger profile 26 to help prevent debris collector 10 from accidently dislodging from frame 18 or working implement 16. Securing lip 70 has a sloped edge 76 to allow for it to slid easily over debris during use.

Debris collector 10 can be attached to a garden tool 12 such as a common yard and garden bow rake. Although there are variations in sizes, the bow rake style and configuration is consistent which will allow for easy interchange of debris collectors 10 and manufacturing. It should also be noted that nearly all existing bow rakes are formed from ridged metal products which is desirable for a number of reasons.

For example, in the case of using gardening tool 12 to assist in burning or fighting fire, gardening tool 12 could be fabricated of metal and incorporate a metal debris collector 10. Shaft 14 can be heat insulated. If gardening tool 12 is metal but is fitted with removable debris collector 10 fabricated of plastic, then debris collector 10 can be removed so there is no risk of melting debris collector 10.

When fabricated from metal, gardening tool 12 will be a ridged structure that will not flex or bend under pressure or force when gardening tool 12 and debris collector 10 are used for shoveling or scooping matter.

Furthermore, when using gardening tool 12 for moving or leveling ground, debris, and or material it is much more efficient if it is rigid so as to cut in and hold its form, leaving behind a shaped worked setting.

It will be appreciated that it may be desirable to incorporate or attach debris collector 10 to gardening tool 12 made from reasonably nonflexible materials and therefore gardening tool 12 could be made from materials other than metal to achieve the desired rigidity.

Most bow rakes are made with a series of level or flat working tines. In conjunction with debris collector 10 this configuration is most desirable because when scooping or using the implement for picking up, a wider path is covered than if one is using a curved or round rake head, thus it gathers a larger load and is more efficient.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A debris collector for a gardening tool, the gardening tool having a shaft, a working implement oriented in angular relation to the shaft, and a frame securing the working implement to the shaft, the frame defining an enclosure, the debris collector comprising:
a scoop that fits within the enclosure defined by the frame, the scoop having a peripheral edge; and
a hanger profile positioned along the peripheral edge, the hanger profile engaging the frame when the scoop is positioned in the enclosure;

2. The debris collector of claim 1, wherein the scoop is provided with an elongated member extending past the peripheral edge, and a clamp on the elongated member clamping onto the shaft of the garden tool.

3. The debris collector of claim 1, wherein at least a portion of the scoop is perforated.

4. The debris collector of claim 1, wherein the scoop has a removable closure.

5. A debris collector and gardening tool combination, comprising:
a gardening tool, comprising:
a shaft;
a working implement oriented in angular relation to the shaft;
a frame securing the working implement to the shaft, the frame defining an enclosure;
a debris collector comprising:
a scoop that positioned within the enclosure defined by the frame, the scoop having a peripheral edge and an elongated member that extends past the peripheral edge;
a hanger profile positioned along the peripheral edge, the hanger profile engaging the frame when the scoop is positioned in the enclosure; and
a clamp on the elongated member, the clamp clamping onto the shaft of the gardening tool.

6. The debris collector and gardening tool combination of claim 5, wherein the gardening tool is one of a rake, a hoe, a claw cultivator, or a tiller.
